(19) United States
(12) Patent Application Publication
(10) Pub. No.: US 2022/0285774 A1
(43) Pub. Date: Sep. 8, 2022

(54) Battery Pack Shield

(71) Applicant: David Muir, Highlands, TX (US)

(72) Inventor: David Muir, Highlands, TX (US)

(21) Appl. No.: 17/686,596

(22) Filed: Mar. 4, 2022

Related U.S. Application Data
(60) Provisional application No. 63/158,056, filed on Mar. 8, 2021.

(51) Int. Cl. H01M 50/242; H01M 50/247; H01M 50/224; B25F 5/00

(52) U.S. Cl. CPC H01M 50/242; H01M 50/247; H01M 50/224; B25F 5/006; H01M 2220/30

(57) ABSTRACT

The present invention relates generally to the field of accessories for cordless power tools. More specifically, the present invention relates to a shield for covering a battery pack of a cordless power tool to allow the user to use the shield for hammering in screws, nails and other fasteners. The shield can be easily attached to a battery pack using adhesives or fasteners. The shield offers a multifunctional use to protect the battery while also serving as a hammer, thereby eliminating the need to constantly switch between tools when hammering, and also giving the battery pack protection against accidental drops.

### CROSS-REFERENCE TO RELATED APPLICATION

The present application claims priority to, and the benefit of, U.S. Provisional Application No. 63/158,056, which was filed on Mar. 8, 2021 and is incorporated herein by reference in its entirety.

### FIELD OF THE INVENTION

The present invention relates generally to the field of accessories for cordless power tools. More specifically, the present invention relates to a shield or guard for covering a battery pack used with a cordless power tool to prevent the battery pack from damage. In addition, the shield allows the user to use the shield or cover for hammering or tapping in screws, nails and other fasteners. The shield or guard is preferably comprised of metal or metal alloy and can be easily attached to the handle of the device or a battery pack using adhesives, e.g., removable, repositionable or permanent, or by fasteners such as screws, bolts, etc. at any orientation such as, but not limited to, a side clip attachment position. The shield offers a multifunctional use to not only protect the battery but also gives the user the additional functionality to serve as a hammer, thereby eliminating the need to constantly switch between tools when hammering or tapping in fasteners, and also giving the battery pack protection against accidental falls or other incidental damage. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, cordless power tools are widely used both in home improvement and the construction industry for a variety of purposes. Those uses include driving or tapping fasteners such as screws, nails, brads, staples and other fastening elements. Generally, a construction project is completed when a variety of sub-tasks that may involve cutting material or driving, drilling, and/or hammering fasteners is done. To complete these sub-tasks, a user may be required to switch between different tools such as a cordless power tool for drilling, a hammer for hammering fasteners, screw drivers, cordless power saws and various other tools. When an individual is working high up on a ladder, carrying multiple tools upwards to certain heights, the switching back and forth between the tools can be extremely difficult and dangerous. Further, if the user prefers not to carry multiple tools up the ladder or while performing a particular task, the individual is then required to climb up and down the ladder repeatedly to replace and retrieve each additional tool as needed. As a result, this constant climbing can be frustrating, exhausting, inefficient and time-consuming for the user.

In addition, a battery pack on a cordless power tool is often used as a hammer for hammering or starting screws, nails, staples, brads and the like. Although hammering may be accomplished using the battery pack of the power tool, the cordless batteries and the battery pack are oftentimes damaged during this process as the head of the nail may puncture the battery compartment. In addition, a user can also use the butt of their power tool's handle as a means to drive screws, nails and the like. to get the fastener started for driving the fastener fully into position with the drill. However, the battery packs of the power tools are also commonly damaged from being used to drive fasteners into building materials in order start the driving process of the fastener.

Additionally, if a cordless power tool is accidently dropped from a large height the battery pack and/or the tool itself may become damaged. The damage can also occur from standard daily wear-and-tear, and both forms of damage can cause the tool to be nonfunctional. As a result, this may force a user to repair the tool or buy a completely new tool. However, both options can be expensive, time-consuming and frustrating, such that they are undesirable for the user.

Therefore, there exists a long-felt need in the art for a guarding device that provides protection to the battery pack of a cordless power tool and prevents the battery pack from being damaged in the event that the tool is accidently dropped or used for hammering or starting the driving of a fastener such as a nail. There is also a long-felt need in the art for a cordless power tool accessory that allows a power tool to be used for multiple purposes, such as for starting fasteners, such that the battery pack of the tool is not damaged even when the pack is utilized for hammering. Moreover, there is a long-felt need in the art for a power tool accessory that eliminates the need to carry multiple tools to complete a specific task (e.g., drilling and hammering), such as the need for a user to constantly climb up and down a ladder to retrieve multiple tools to complete multiple differing actions. Further, there is a long-felt need in the art for a cordless power tool accessory that eliminates the need to switch between different tools for performing various tasks such as drilling and hammering. Furthermore, there is a long-felt need in the art for a cordless power tool accessory that can be easily attached to a handle or battery pack of a standard cordless power tool for utilizing the tool and battery pack for multiple purposes. Finally, there is a long-felt need in the art for a cordless power tool protective accessory that allows users to drive screws or fasteners into building and other material using the battery pack of the tool, without damaging the battery pack of the tool.

The subject matter disclosed and claimed herein, in one embodiment thereof, comprises a battery pack shield or guard for use with a cordless power tool battery pack. The shield or guard is configured to be used for hammering purposes without causing damage to battery pack, and also for protecting the battery pack against damage caused due to dropping the cordless tool or pack, or other incidental damage caused during use of the tool. More specifically, the shield or guard includes a rear wall to protect the butt of the battery pack. The rear wall has two longitudinal edges, a top edge and a bottom edge, and a pair of side walls extending transversely away from the longitudinal edges of the rear wall for protecting the side surfaces of a handle and battery pack. A top wall extends transversely from the top edge of the rear wall to protect the butt of the handle of the cordless power tool. Further, any of the rectangular rear wall, pair of side walls or the top wall can be used for hammering, tapping or driving in a nail, screw, staple, brad or other fastener of the like into a surface such as a piece of material.

In this manner, the battery pack shield or guard accessory for a cordless power tool battery pack of the present invention accomplishes all of the forgoing objectives and provides a protective accessory for the battery pack of a cordless power tool. The shield or guard further allows a user to hammer in a fastener using the battery pack of the tool, without requiring a separate hammer or tool and without damaging the battery pack of the tool. Therefore, a user does not need to carry multiple tools while performing a job that has a variety of differing tasks, which results in high efficiency and utility for the user.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a battery pack shield or guard for a battery pack used with a cordless power tool such as a drill, saw or other tool. The shield or guard is made up of a durable metal or metal alloy and is configured to protect the batteries or battery pack of a cordless power tool from damage caused due to droppage, or physical impacts such as using the tool as a hammer or to tap in a fastener. The shield further includes a pair of trapezoidal lateral enclosure walls, a rectangular top enclosure wall, and a rectangular rear enclosure wall. The shield is open from the bottom and front to form a cavity therein, which allows the shield to encase and cover much of a battery pack of a cordless power tool. Further, the trapezoidal lateral enclosure walls are permanently joined to longitudinal edges of the rear enclosure wall and extend transversely from the rear enclosure wall, the rectangular top enclosure wall is permanently joined to the top edge of the rear enclosure wall and extends transversely away from the rear enclosure wall in the direction of extension of the trapezoidal lateral walls, and one of the trapezoidal lateral enclosure walls has a continuous opening. The continuous opening is positioned and dimensioned as per any existing side clip hole that may be present on the handle of a cordless power tool. The continuous opening is aligned with the side clip hole and fastened using a screw to cover the battery pack using the lateral, top and rear walls for providing protection against a physical impact. The rear enclosure wall further protects the butt of the battery pack of the power tool.

It should be noted that in a further embodiment, the trapezoidal lateral enclosure walls are parallel to each other, and the rectangular rear enclosure wall covers the back or butt of the battery pack of a cordless power tool. The trapezoidal lateral enclosure walls also cover the sides of the battery back and the handle of the tool. Further, in any embodiment of the present invention, the shape and dimensions of the walls of the shield may be any geometric shape and can depend on the design and size of the handle and battery pack of the cordless power tool as well as the type of power tool and battery pack that is in use.

In a differing embodiment of the present invention, a battery pack shield or guard for a cordless power tool battery pack is disclosed. The shield is configured to be used for hammering, driving or impacting purposes, while preventing damage to batteries or a battery pack of a cordless tool. The metal shield includes a rear wall to protect the butt or rear of the battery pack. The rear wall has two longitudinal edges, a top edge and a bottom edge, a pair of side walls extending transversely away from the longitudinal edges of the rear wall that protect the side surfaces of a tool handle and battery pack, and a top wall extending transversely from the top edge of the rear wall to protect butt or rear of the handle of the cordless power tool. Further, any of the rectangular rear wall, pair of side walls or the top wall can be used for hammering, driving or otherwise impacting a nail, screw or other fastener into a surface. The rear wall may also have a magnetic element so as to allow the user to magnetically attach fasteners for use when needed.

In yet a further embodiment of the present invention, a method of protecting a battery pack of a cordless power tool using a shield or guarding element is disclosed. The method includes the steps of initially positioning a metal cover or shield around several sides of the battery pack at the end of a handle of the cordless power tool, such that a pair of side walls, a top wall and a rear wall of the metal cover protects the side surface of a handle of a power tool, the butt or rear of the handle and the battery. The shield protects most of the exposed surfaces of the battery pack but still allows the user to easily remove the battery pack from the tool without having to first remove the shield. Then, a user aligns an opening of the side wall of the shield with a side clip hole of the handle of the tool, and fastens the shield using a mechanical fastener or adhesive such that the continuous opening and the side clip hole receive the mechanical fastener to secure the shield around the periphery of the battery pack. The method further includes hammering or driving a nail, screw, staple, brad or other fastener into a material using any of the walls of the metal shield that is secured to the battery pack, without damage to the batteries or battery pack.

In yet another embodiment of the present invention, the shield can be secured to the cordless power tool using a plurality of mechanical fasteners. In this embodiment, both side walls of the shield may have openings. The openings then allow mechanical fasteners to be used to secure the shield or guard to the handle and battery pack of the cordless power tool.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a battery pack shield or guard for a cordless power tool battery pack of the present invention in accordance with the disclosed structure;

FIG. 2 provides a perspective view displaying how one potential embodiment of a battery pack accessory for a cordless power tool battery pack of the present invention is secured to the battery pack of a cordless power tool;

FIG. 3A depicts a perspective view showing one potential embodiment of a battery pack shield or guard for a cordless power tool battery pack of the present invention being used as a hammer or impact device to first hit a fastener so that it is started into a material in accordance with the disclosed specification;

FIG. 3B depicts a perspective view showing one potential embodiment of a battery pack shield or guard for a cordless power tool battery pack of the present invention being used as a hammer or impact device to first hit a fastener so that it is started into a material in accordance with the disclosed specification

FIG. 4 displays a perspective view showing the use of the power tool for drilling a screw after being initially started using one potential embodiment of a battery pack shield for a cordless power tool battery pack of the present invention;

FIG. 5 illustrates a perspective view of another potential embodiment of a battery pack shield for a cordless power tool battery pack of the present invention in accordance with the disclosed structure; and

FIG. 6 provides a flow chart of the steps of a method of encasing a battery pack of a cordless power tool using one potential embodiment of a battery pack shield for a cordless power tool battery pack of the present invention is disclosed.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a protective accessory or other device that provides a shield or guard for the battery pack of a cordless power tool and prevents the battery pack from being damaged in the event that the tool is accidently dropped or otherwise encounters an unintended impact. There is also a long-felt need in the art for a cordless power tool accessory that allows a power tool to be used for additional purposes such as hammering or driving fasteners, such that the battery pack of the tool remains safe and undamaged even when the pack is utilized for hammering or starting or driving a fastener. Moreover, there is a long-felt need in the art for a power tool accessory that eliminates the need to carry multiple tools to complete a specific task (e.g., drilling and hammering), and that prevents a user from constantly climbing up and down a ladder to retrieve other tools to complete multiple different actions. Further, there is a long-felt need in the art for a cordless power tool accessory that eliminates the need to switch between different tools for performing other tasks such as between drilling and hammering. Furthermore, there is a long-felt need in the art for a cordless power tool accessory that can be easily attached to a handle or the battery pack of a standard cordless power tool for utilizing the tool and battery pack for different purposes. Finally, there is a long-felt need in the art for a cordless power tool protective accessory shield that allows users to drive or start fasteners into material using the battery pack of the tool, but without damaging the battery pack of the tool.

The present invention, in one exemplary embodiment, comprises a novel battery pack shield or guard for a cordless power tool battery pack. The shield protects the battery pack of a cordless power tool from damage which may be caused due to physical impacts or drops. More specifically, the shield includes a pair of trapezoidal lateral or side enclosure walls, a rectangular top enclosure wall and a rectangular rear enclosure wall. The shield is open from the bottom and front to form a cavity therein, which allows the shield to substantially encase and cover a major portion of the exposed battery pack of a cordless power tool. One of the trapezoidal lateral enclosure walls has an opening that is positioned and dimensioned for aligning to a side clip hole of the handle of the cordless power tool. The opening of the shield is aligned with the side clip hole and the shield is fastened using a screw to cover the battery pack using the lateral, top, and rear walls of the shield to provide protection against a physical impact. In an alternate arrangement, the shield may be removably or permanently adhered to the battery pack by an adhesive such as a removable, repositionable or permanent adhesive.

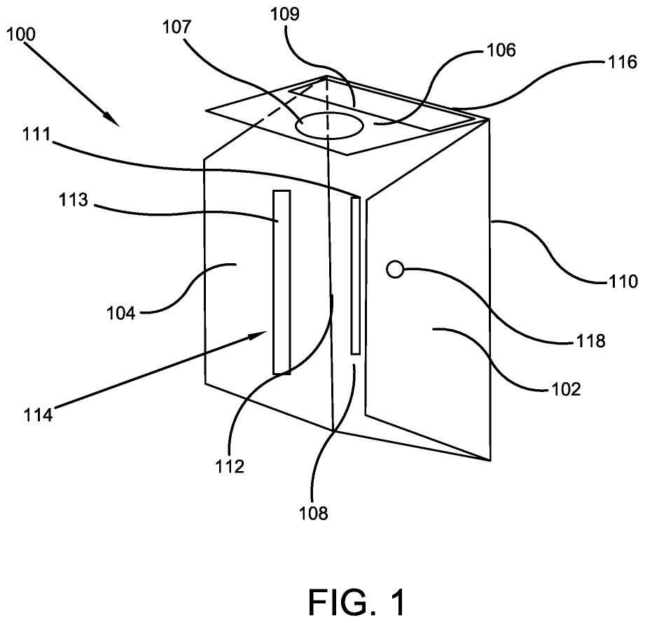

Referring initially to the drawings, FIG. 1 illustrates a perspective view of one potential embodiment of a battery pack shield accessory for a cordless power tool battery pack 100 of the present invention. The battery pack accessory for a cordless power tool battery pack 100 is configured to be used as a shield or guard for a cordless power tool 200 such as but not limited to a drill, and is also designed to be used for hammering, tapping in or driving in screws, nails, staples, brads and other fasteners. The shield or guard 100 fits over a substantial portion of the battery pack 202 of a cordless power tool 200 when the battery pack 202 is coupled to the power tool. The shield or guard protects the batteries or battery pack 202 if the power tool 200 is dropped or impacts another object, while also allowing the battery pack 202 and tool 200 to be used as a multifunctional hammering tool.

The shield 100 is preferably manufactured from a sturdy and durable metal or metal alloy that does not lose its shape when used to hammer a nail, screw or other fastener into a material, such as but not limited to: a wall, ceiling, wood, drywall, etc. In one exemplary and non-limiting embodiment, the shield 100 may be a single unit and includes a first trapezoidal lateral enclosure wall 102 and a second trapezoidal lateral enclosure wall 104. Both the first trapezoidal lateral enclosure wall 102 and the second trapezoidal lateral enclosure wall 104 extend transversely from a pair of longitudinal edges 110 and 112 of a rear enclosure wall 108. The first trapezoidal lateral enclosure wall 102 and the second trapezoidal lateral enclosure wall 104 further protect the side surfaces 206 of a handle 204 and the battery pack 202 of a cordless power tool device 200. The rear wall 108 may be generally rectangular or square and is dimensioned to protect the base, rear or butt 208 of a battery pack 202. A top enclosure wall 106 also extends transversely away from the rear wall 108 and is joined to a top edge 116 of the rear wall 108. Top enclosure wall 106 may also include a magnet 107 which may be used to hold fasteners while the power tool is used for other purposes until the shield is needed for hammering. The top enclosure wall 106 may also have a hardened or reinforced area 109 to facilitate the hammering or impacting of a fastener when needed. The reinforced area may be on any of the walls of the shield depending on the preferences of the user.

The first trapezoidal lateral enclosure wall 102 has an opening or a hole 118 positioned and dimensioned such that it is aligned to a side clip opening 212 (which is typically used for hanging a cordless power tool 200 from a worker's belt or pant pocket) of the handle 204 of the cordless power tool 200 when the shield 100 is placed on the battery pack 202. A mechanical fastener, such as a screw or removable clip, can be used to insert through the opening 118 to fasten and secure the shield 100 to the battery pack 202 and the handle 204 to provide protection against physical impacts or dropping. In differing embodiments, the number of openings 118 can be any number (but preferably at least one) to allow for the securing of the shield 100 to a battery pack 202. Alternatively, the shield 100 can use an adhesive 111 and 113 to removably or permanently hold the shield onto the power tool. It should be understood that the shield is positioned on the battery pack in such a manner that it does not interfere with the charging of the battery pack.

It should be noted that any wall 102, 104, 106, 108 of the shield 100 can be used for hammering, tapping or driving nails, screws, staples, brads or other fasteners of the like into a surface 304. As a result, the hammering can be easily performed without having to reach for a separate hammer or different tool, and without causing any damage to the batteries or battery pack 202 of the tool 200 when performing the hammering. The lateral enclosure walls 102, 104 may further be of any geometric shape and can be designed to cover the portion of handle 204 and full side surfaces 206 of the battery pack 202. The walls do not interfere with the gripping of the handle of the drill or the operation of the tool. The lateral walls 102,104, the top wall 106, and the rear wall 108 accordingly form a cavity 114 that allows the shield 100 to at least partially encase a battery pack 202 and a portion of the handle 204 of a cordless power tool device 200. Further, any surface or wall 102, 104, 106, 108 of the shield 100 may have any indicia 405 such as a logo, pattern, or design for aesthetic appeal and also for marketing and branding.

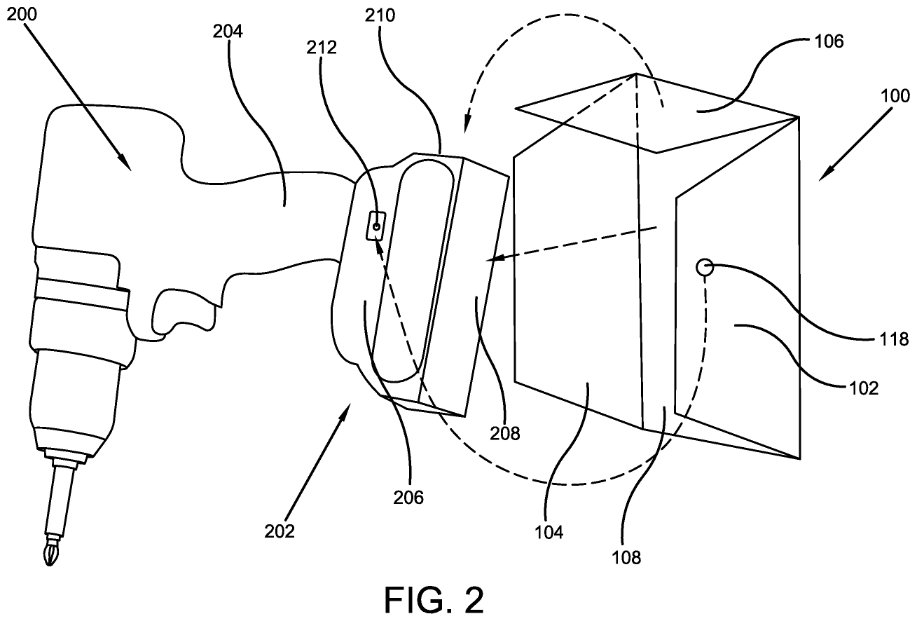

FIG. 2 illustrates a perspective view displaying how one potential embodiment of a battery pack shield for a cordless power tool battery pack 100 of the present invention is secured to the battery pack 202 of a cordless power control tool 200. To secure and cover a battery pack 202 of a cordless power tool 200 with the shield 100 of the present invention, the rear enclosure wall 108 is adhered to the butt or base 208 of the battery pack 202. The first side or lateral wall 102 has an opening 118 that covers the side surface 206 of the battery pack 202 and the opening 118 aligns with a side clip hole 212 of the handle 204 to allow a mechanical fastener or clip to fasten the first lateral wall 102 to the side surface 206 of the tool. Since the shield 100 is dimensioned to fit the battery pack 202 of the cordless power tool 200, the top enclosure wall 106 covers the handle's butt or base 210 as well. The second side surface 104 further covers or adheres to the other side surface (not shown) that is opposite to the shown side surface 206 of the battery pack 202 (e.g., both side surfaces 206 of the pack 202).

It is further contemplated that the shield 100 substantially covers the exposed surfaces of the battery pack 202 and is tightly secured to the power tool using at least one fastener inserted into the aligned opening 118 and side clip hole 212. It should be noted that additional openings 118 may be present on any of the walls 102, 104, 106, 108 of the shield 100, thereby allowing additional mechanical fasteners, clips or pins to be used for securing the shield 100 to the battery pack 202. The side walls 102, 104 may also cover a slight portion of the handle 204 for protection, in a manner such that they do not impede the usage of the tool 200.

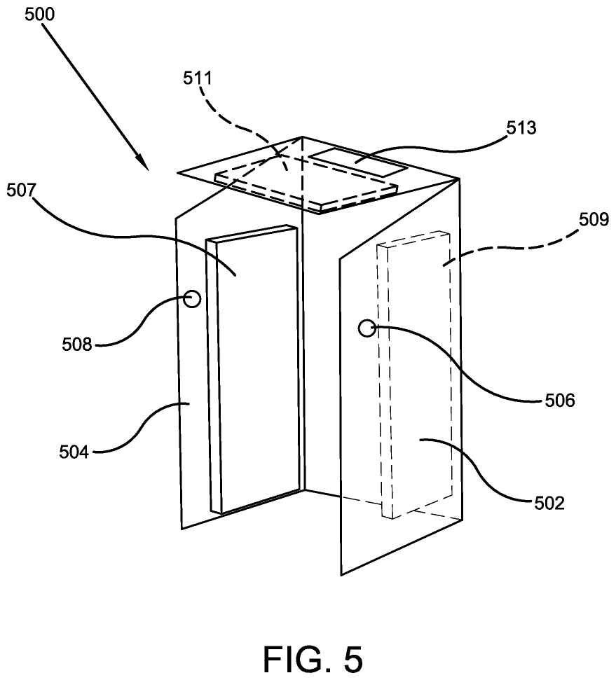

The walls 102, 104, 106, 108 can also adhere to the battery pack 202 via an adhesive, such as a removable, repositionable, activatable or permanent adhesive and protect the pack 202 from any physical damage. Further, any of the walls 102, 104, 106, 108 can be used for hammering, starting or driving a screw, nail, brad, staple or other fastener or the like into in a material without causing damage to the handle 204 and battery pack 202 of the tool 200. Accordingly, the shield 100 absorbs the physical impact caused due to using the tool 200, handle 204 and/or battery pack 202 for hammering, and thus protects the handle 204 and battery pack 202. A foam layer or other insulation as shown in FIG. 5 may be provided to absorb some of the impact force to lessen any damage to the tool itself.

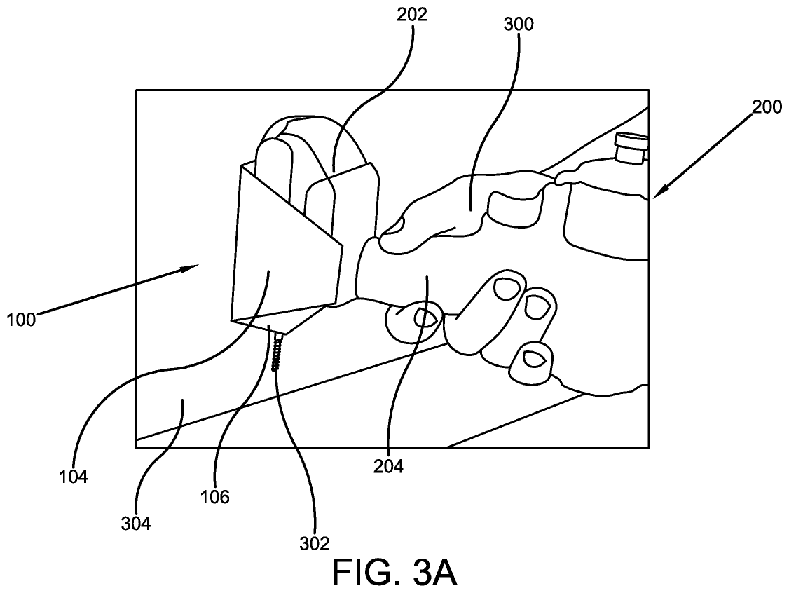

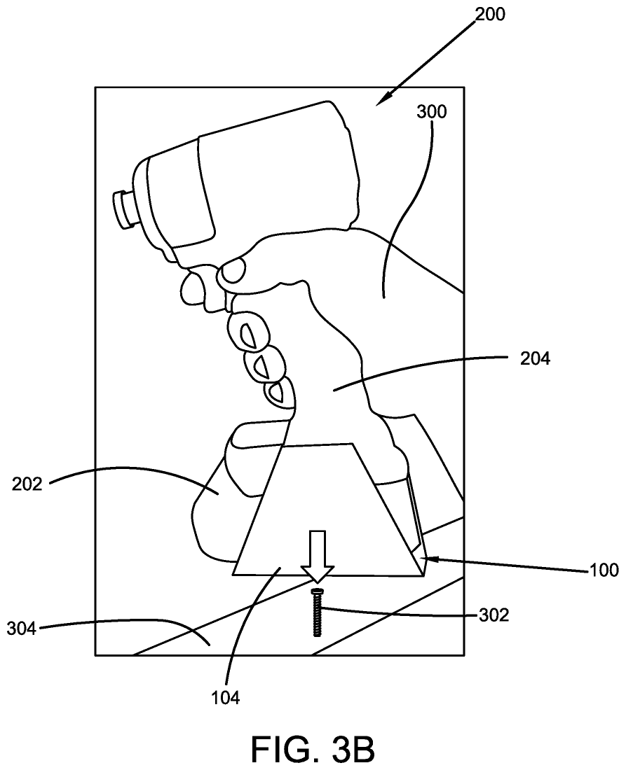

FIGS. 3A and B illustrate a perspective view showing one potential embodiment of a battery pack shield or guard for a cordless power tool battery pack 100 of the present invention being used as an impact device to hammer or first hit a fastener 302 so that it is started into a material 304 in accordance with the disclosed architecture. In the present embodiment, the shield 100 is secured around the battery pack 202 of the cordless power tool 200. As stated earlier, any of the walls 102, 104, 106, 108 of the shield 100 can be used to hammer or drive a screw or other fastener into a surface. Further, the shield 100 may be made of a sturdy, durable, and magnetic or non-magnetic metal or alloy. In the magnetic embodiment of the shield 100, the walls 102, 104, 106, 108 can be used to hold screws 302 or other metal fasteners. In the present embodiment, the top wall 106 can be used for hammering a screw 302 into a surface 304 by conveniently holding the tool 200 by the handle 204 using a single hand 300. It should be noted that the lateral wall 104 does not impede the operation of hammering the screw 302. However, the power tool 200 should be flipped from its normal orientation for drilling after having been used as a hammer for driving fasteners without causing any damage to the battery pack 202 and handle 204.

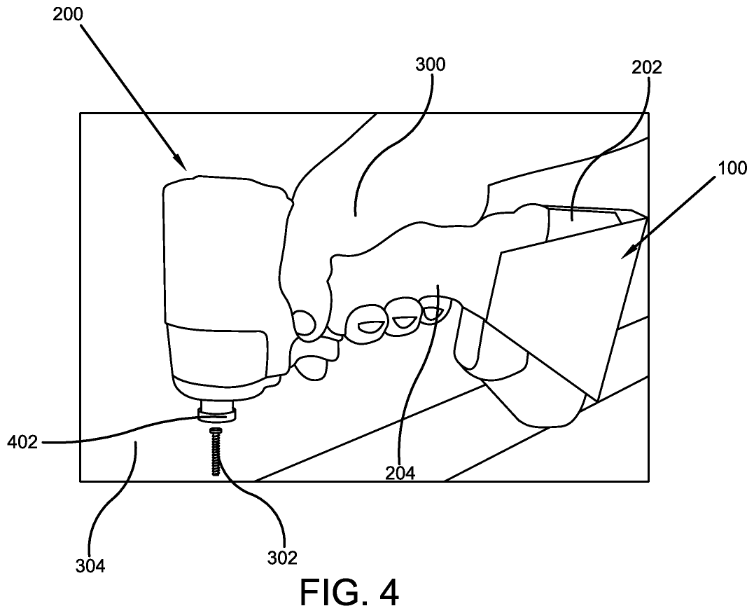

FIG. 4 illustrates a perspective view showing the use of the power tool 200 for drilling a screw 302 after being hammered using one potential embodiment of a battery pack shield for a cordless power tool battery pack 100 of the present invention. As shown in FIG. 3, the shield 100 is used for hammering a screw 302 into a surface 304 by holding the handle 204 of the power tool 200. Once the screw 302 is partially inserted into the surface 304 as desired, the power tool 200 can be flipped using the handle 204 to allow the shield 100 to go to the rear position and to allow the drill bit 402 of the power tool 200 to be used for drilling the screw 302 completely into the surface 304, as would normally be done.

FIG. 5 illustrates a perspective view of another potential embodiment 500 of a battery pack shield for a cordless power tool battery pack 100 of the present invention. In the present embodiment 500, the lateral or side surfaces 502, 504 of the shield 500 are shown as generally rectangular in dimension instead of being trapezoidal as in the earlier embodiments. Further, the first lateral surface 502 has a first opening 506 and a second lateral surface 504 has a second opening 508. Both the holes 506, 508 are used for fastening and securing the metal shield 500 around a battery pack 202 of a cordless power tool 200. FIG. 5 also shows an insulation or padding element 507, 509 and 511 which can be used to absorb the impact forces used when the shield is hammering or starting a fastener. The padding or insulation may be provided on all or some of the walls depending on the requirements of the user, and may only be positioned on the impact surface where there is a reinforced driving element 513 on the particular wall.

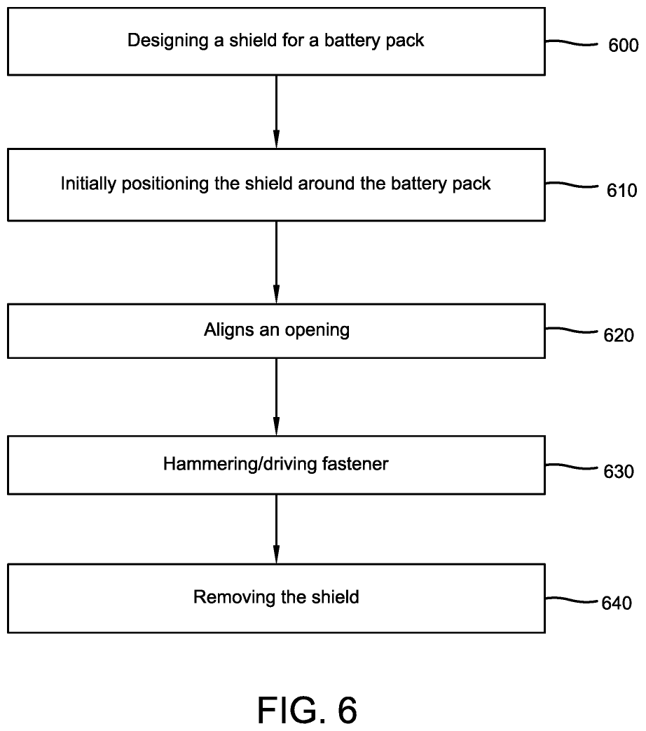

FIG. 6 illustrates a flow chart of the essential steps of a method of encasing a battery pack of a cordless power tool which includes the steps of designing a shield at step 600 using one potential embodiment of a battery pack shield for a cordless power tool battery pack 100 of the present invention is disclosed. The method includes the steps of initially positioning the shield 100 around the battery pack 202 at the end of a handle 204 of a cordless power tool 200 such that a pair of side walls 102, 104, a top wall 106, and a rear wall 108 of the shield enclose the side surface of a handle 204 of the power tool 200, the butt of the handle 210, and the battery pack 202 at step 610. Then, a user aligns a continuous opening 118 of the side wall 102, 104 with a side clip hole 212 of the handle 204 and fastens the shield 100 using a mechanical fastener, clip or pin such that the continuous opening 118 and the side clip hole 212 receive the mechanical fastener to secure the shield 100 around the battery pack 202 at step 620. The method further includes hammering/driving a nail, screw or other fastener into a building material using any of the walls 102, 104, 106, 108 of the shield 100, wherein the shield 100 is secured to the battery pack 202 and wherein no damage to the batteries or battery pack 202 occurs at step 630. At step 640, the shield is removed from the tool.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “battery pack shield for a cordless power tool battery pack”, “metal shield” and “shield” are interchangeable and refer to the battery pack shield for a cordless power tool battery pack 100, 500 of the present invention.

Notwithstanding the forgoing, the battery pack shield for a cordless power tool battery pack 100,500 of the present invention can be of any suitable size and configuration as is known in the art without affecting the overall concept of the invention, provided that it accomplishes the above-stated objectives. One of ordinary skill in the art will appreciate that the size, configuration, and material of the battery pack shield for a cordless power tool battery pack 100,500 as shown in the FIGS. are for illustrative purposes only, and that many other sizes and shapes of the battery pack shield for a cordless power tool battery pack 100,500 are well within the scope of the present disclosure. Although the dimensions of the battery pack shield for a cordless power tool battery pack 100,500 are important design parameters for user convenience, the battery pack shield for a cordless power tool battery pack 100,500 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An accessory for a cordless power tool having a removable battery pack, the accessory comprising:
an enclosure sized and configured for positioning around the removable battery pack, wherein the enclosure is a hardened shield;
the enclosure is attached to a handle of the cordless power tool or the removable battery pack; and
the enclosure comprising a base, a plurality of walls and an opening for allowing for the removable battery pack to be positioned within the hardened shield.

2. The accessory for a cordless power tool as recited in claim 1, wherein the enclosure is attached to the handle or the removable battery pack by one of a fastener or an adhesive.

3. The accessory for a cordless power tool as recited in claim 2, wherein the adhesive is one of a repositionable, a removable, an activatable or a permanent adhesive.

4. The accessory for a cordless power tool as recited in claim 1, wherein at least one of the plurality of walls has an opening for insertion of a fastener to secure the enclosure to the cordless power tool.

5. The accessory for a cordless power tool as recited in claim 1, wherein the enclosure comprises a magnetic element for holding fasteners.

6. The accessory for a cordless power tool as recited in claim 1, wherein the enclosure has a reinforced or hardened area for driving or hammering a fastener.

7. The accessory for a cordless power tool as recited in claim 1, wherein the enclosure comprises an insulation for dampening an impact vibration.

8. The accessory for a cordless power tool as recited in claim 1, wherein the plurality of walls is comprised of three walls extending outwardly from a base.

9. The accessory for a cordless power tool as recited in claim 8, wherein the three walls and the base do not interfere with a handle on the cordless power tool or operation of the cordless power tool.

10. The accessory for a cordless power tool as recited in claim 9, wherein one of the three walls is adjustable against a butt of the removable battery pack and two of the three walls are positioned against sides of the removable battery pack.

11. A combination cordless drill, battery pack and shield comprising:
a cordless drill;
a battery pack, wherein the battery pack is removably attached to the cordless drill and is comprised of a base, a plurality of side walls and a top; and
a shield for connecting to the battery pack, wherein the shield comprises a base and at least three walls extending outwardly from the base, and further wherein the base of the shield is in contact with the base of the battery pack and the at least three walls of the shield are in contact with plurality of walls of the battery pack.

12. The combination cordless drill, battery pack and shield as recited in claim 11, wherein the shield comprises a magnetic area for magnetically holding a fastener.

13. The combination cordless drill, battery pack and shield as recited in claim 11, wherein the shield comprises a reinforced or hardened impact area.

14. The combination cordless drill, battery pack and shield as recited in claim 11, wherein the shield is attached to the battery pack by an adhesive.

15. The combination cordless drill, battery pack and shield as recited in claim 14, wherein the adhesive is one of a repositionable, a removable, an activatable or a permanent adhesive.

16. The combination cordless drill, battery pack and shield as recited in claim 11, wherein the shield is attached to the cordless drill by an opening in one of the three walls and insertion of a fastener.

17. A shield for a battery pack, the shield comprising:
a base having a back wall and two side walls extending upwardly from the base;
each of the back and two side walls are perpendicular to the base and wherein the base is comprised of an open end;
the open end of the base is sized and configured to receive the battery pack; and
one of the base or two side walls is attached to the battery pack by an adhesive or a fastener, and wherein the base, the back wall and the two side walls form a shield for the battery pack.

18. The shield for a battery pack as recited in claim 17, wherein the base, back wall and two side walls are formed from a metal or a metal alloy.

19. The shield for a battery pack as recited in claim 17, wherein at least one of the base, back wall and two side walls comprises a magnetic element.

20. The shield for a battery pack as recited in claim 17, wherein at least one of the base, back wall and two side walls comprises a reinforced or hardened area.
